(19) United States
(12) Patent Application Publication
(10) Pub. No.: US 2008/0109787 A1
(43) Pub. Date: May 8, 2008

(54) METHOD AND SYSTEM FOR FUNCTION REFERENCE OF DEVELOPMENT TOOL

(75) Inventors: Hui-Min Wang, Taipei City (TW); Hung-Lin Chou, Taipei County (TW); Chia-Ching Lin, Pingtung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: SUNPLUS TECHNOLOGY CO., LTD., Hsinchu (TW)

(21) Appl. No.: 11/936,089

(22) Filed: Nov. 7, 2007

(30) Foreign Application Priority Data
Nov. 7, 2006 (TW) 95141126

(51) Int. Cl. G06F 9/44

(52) U.S. Cl. 717/113

(57) ABSTRACT

A function reference method of a development tool and a system thereof are disclosed. According to the function reference method, new function database and classified data are described with a text file or a database format file. After the file is read by an add-in module of the development tool, the desired function or object can be loaded into the editing workspace of the development tool through a hierarchical menu or by detecting an input string. Therefore, users can quickly searching and loading new functions.

### CROSS-REFERENCE TO RELATED APPLICATION

This application claims the priority benefit of Taiwan application serial no. 95141126, filed on Nov. 7, 2006. The entirety of the above-mentioned patent application is hereby incorporated by reference herein and made a part of this specification.

### BACKGROUND OF THE INVENTION

1. Field of the Invention

The present invention relates to a function reference method and a system thereof. More particularly, the present invention relates to a method for searching and loading new functions in a development tool and a system thereof.

2. Description of Related Art

Presently, if a cell phone or personal digital assistant (PDA) software provider does not have its own compiler technique, their software has to be integrated with Microsoft Visual C or .Net Visual Studio in MS Windows environment. The aforementioned integration mechanism cannot provide the software provider with a complete manipulation over the development environment. Thus, the desired function information can only be obtained through an application programming interface (API) or a software development kit (SDK) when developing tools or function database.

None of the existing integrated development environments (IDE) can provide a convenient query mechanism for a new function database, even in Microsoft developer network (MSDN) or in the function database defined by a .cpp file or a .h file corresponding to the whole project, a user has to enter the title of the function database through a specific interface or enter the complete title of the function or object to search for new functions.

For example, when a user inputs the function title “MessageBox”, the function prototype “int MessageBox(HWND hWnd, LPCTSTR lpText, LPCTSTR lpCaption, UINT uType)” of the function “MessageBox” is popped up in the editing workspace. The user then edits the program according to his/her requirement by adding suitable properties or text. However, the user has to enter the complete function title for searching for the desired function prototype with the method described above. As for a newly added function database, the user has to use additional tools for searching for new functions since the user is not familiar with the titles of the new functions, and there has been no effective and convenient query mechanism provided.

### SUMMARY OF THE INVENTION

Accordingly, the present invention is directed to a function reference method of a development tool, wherein an external function database classified file is read first by an add-in module, and a hierarchical classification way is provided for a user to select the desired function and load the function prototype into the editing workspace of the development tool, so that the functions can be managed and the user can search and load new functions conveniently.

According to another aspect of the present invention, a function reference method of a development tool is provided, wherein an external function database classified file is read first by an add-in module, and a string input by a user is then detected for displaying and adding all the functions corresponding to the string, so that the functions can be managed and the user can search and load new functions conveniently.

To achieve the aforementioned and other objectives, the present invention provides a function reference method suitable for searching and loading a function in a development tool. The method includes following steps. First, an external function database is connected through an add-in module to read a function database classified file, wherein the function database classified file includes a plurality of function database types. Next, when the add-in module detects that one of the function database types is selected, a plurality of functions corresponding to the selected function database type are displayed. Next, when the add-in module detects that one of the functions is selected, the selected function is loaded into the editing workspace of the development tool.

According to an embodiment of the present invention, a memory block is further provided for recording the function database classified file after reading the function database classified file.

According to an embodiment of the present invention, if the number of function database types or functions to be displayed exceeds a page, a scroll bar or a PageUP/PageDown button is provided for a user to select the function database types or functions quickly.

According to an embodiment of the present invention, the selected function may be loaded into the editing workspace of the development tool by dragging and dropping the function into the editing workspace of the development tool or by pressing down an input button.

According to an embodiment of the present invention, a memory block is further provided for recording the function database classified file after the step of reading the external function database classified file.

According to an embodiment of the present invention, if the selected function database type further includes a plurality of secondary function database types, the step of displaying the functions corresponding to the function database type further includes displaying the secondary function database types.

According to an embodiment of the present invention, the function database classified file includes one of a text file and a database format file, and the functions include one of object classes and member functions or variables.

The present invention further provides a function reference method suitable for searching and loading a function in a development tool. The method includes following steps. First, an external function database is connected through an add-in module for reading a function database classified file, wherein the function database classified file includes a plurality of functions. Next, when the add-in module detects that a string is input by a user, all the functions starting with that string are displayed. Next, when the add-in module detects that the user selects one of the functions, the selected function is loaded into the editing workspace of the development tool.

According to an embodiment of the present invention, a memory block is further provided for recording the function database classified file after reading the function database classified file.

According to an embodiment of the present invention, if the input string is a letter, all the functions starting with that letter are displayed, and if the input string contains a plurality of letters and the input intervals between the letters are shorter than a particular time, all the functions starting with those letters are displayed.

According to an embodiment of the present invention, if the number of functions to be displayed exceeds a page, a scroll bar or a PageUp/PageDown button is provided for a user to select the functions quickly.

According to an embodiment of the present invention, the selected function is loaded into the editing workspace of the development tool by dragging and dropping the function into the editing workspace of the development tool or by pressing down an input button.

According to an embodiment of the present invention, a memory block is further provided for recording the function database classified file after the step of reading the external function database classified file.

According to an embodiment of the present invention, the function database classified file includes one of a text file and a database format file, and the functions include one of object classes and member functions or variables.

The present invention provides a function reference system of a development tool, and the function reference system includes a storage unit, a display unit, and an add-in module. The storage unit is suitable for storing a function database classified file of the development tool, wherein the function database classified file includes a plurality of function database types, and each function database type includes a plurality of functions. The display unit is suitable for displaying the function database types and the functions. The add-in module is suitable for connecting to an external function database for reading the function database classified file, storing the function database classified file into the storage unit, detecting the selected function database type or function, and providing the selected function data type for the display unit to display or loading the selected function into the editing workspace of the development tool.

According to an embodiment of the present invention, if the add-in module detects that one of the function database types is selected, the add-in module provides the functions corresponding to the function database type for the display unit to display, and if the add-in module detects that one of the functions is selected, the add-in module loads the selected function into the editing workspace of the development tool.

The present invention provides a function reference system of a development tool. The function reference system includes a storage unit, a display unit, and an add-in module. The storage unit is suitable for storing the function database classified file of the development tool, wherein the function database classified file includes a plurality of function database types, and each of the function database types includes a plurality of functions. The display unit is suitable for displaying the functions. The add-in module is suitable for connecting to an external function database for reading the function database classified file, storing the function database classified file into the storage unit, detecting an input string, searching for functions corresponding to the string in the function database classified file, and providing the functions for the display unit to display or loading the functions into the editing workspace of the development tool.

According to an embodiment of the present invention, if the add-in module detects an input string, the add-in modules searches for all the functions starting with the string in the function database classified file and provides the functions for the display unit to display, and if the add-in module detects that one of the functions is selected, the add-in module loads the selected function into the editing workspace of the development tool.

According to the present invention, new function database and classified data are stored in an function database classified file in an external function database, and after the function database classified file is read by an add-in module of the development tool, the user can quickly search and load the desired function by selecting menus or input the first few letters of the function title.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a function reference method of a development tool according to an exemplary embodiment of the present invention.

FIG. 2 illustrates an example of a function reference method of a development tool according to an exemplary embodiment of the present invention.

FIG. 3 illustrates a function reference method of a development tool according to another exemplary embodiment of the present invention.

FIG. 4 illustrates an example of a function reference method of a development tool according to another exemplary embodiment of the present invention.

### DESCRIPTION OF EMBODIMENTS

The foregoing and other features, aspects, and advantages of the present invention will be described and become more apparent from the detailed description of exemplary embodiments when read in conjunction with accompanying drawings.

According to an embodiment of the present invention, new function database and classified data to be provided for the users are described with a text file or a database format file. The file is placed in a sorted directory and is read hierarchically by an add-in module so that a user can search for the desired function level by level according to the classification of the function. Accordingly the user can manipulate the entire function database quickly.

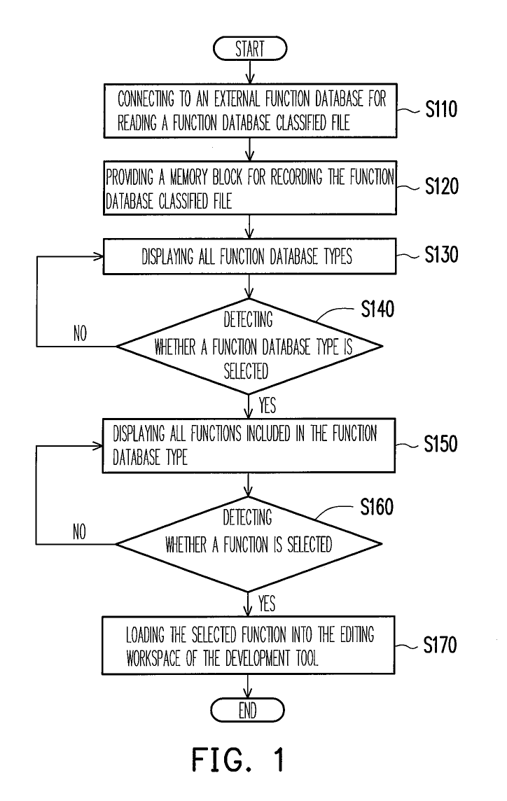

FIG. 1 illustrates a function reference method of a development tool according to an exemplary embodiment of the present invention. Referring to FIG. 1, the present embodiment is suitable for searching and loading a function in a development tool. Wherein the development tool may be a software development tool such as Microsoft Visual C but is not limited thereto as such.

First, an add-in module of the development tool is used for connecting to an external function database for reading a function database classified file (step S110). Wherein the function database classified file includes a plurality of function database types and the add-in module may be a hierarchical module added in the tool list of the development tool for providing function classification information for the users. The concept of hierarchical module is to classify all functions into a plurality of function database types according to the characteristics of the functions, and each function database type is further divided into a plurality of secondary function database types, and so on, so as to establish a complete function database classified file. For example, if a user needs a graphic, archival, or system function, the user can quickly locate the corresponding function according to the classification of such function with the guiding of the hierarchical module.

Besides, the add-in module provides a memory block for recording the function database classified file when the add-in module reads the function database classified file (step S120), and later on when a user searches for function data, the function database classified file can be accessed directly from the memory, so that the user can browse and search for functions quickly.

Next, all the function database types are displayed in the screen (step S130). Here the user can select the function database type that his desired function belongs to by using the add-in module and the add-in module then detects whether a function database type is selected (step S140). When the add-in module detects that a function database type is selected, it displays all the functions corresponding to the function database type in the screen (step S150), otherwise the process returns to step S130 to display all the function database types. Wherein if the selected function database type further includes a plurality of secondary function database types, the add-in module displays the secondary function database types first, and the user can select the function database types level by level until the final function database is found.

After that, the user can select the desired function from all the functions included in the final function database, and here the add-in module detects whether a function is selected (step S160). If the add-in module detects that a function is selected, the add-in module loads the selected function into the editing workspace of the development tool (step S170); otherwise the process returns to step S150 to display all the functions included in the function database type. The selected function may be loaded into the editing workspace of the development tool by dragging and dropping the function into the editing workspace of the development tool or by pressing down an input button, but which is not limited thereto as such.

Besides, in the present embodiment, if the number of the function database types or functions to be displayed exceeds the display range of a page, a scroll bar is provided beside the display window for the user to move up and down to select the desired function, or a PageUp/PageDown button is provided in the display window for the user to click on and browse the desired function database type or function.

It should be mentioned here that the present embodiment is suitable for the function database classifications of general application program interfaces (API) but is not limited thereto. If the present embodiment is applied to an object-oriented development tool, the object classes and member functions/variables thereof may be classified by the add-in module in the present invention, and a user can select the desire object through a hierarchical menu.

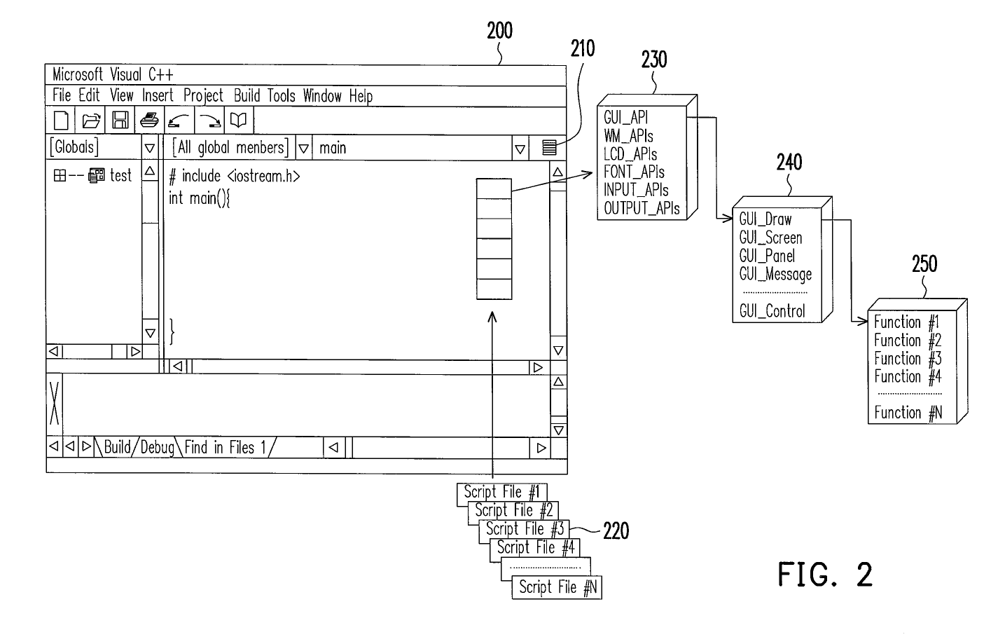

An embodiment of the present invention will be described in detail below for explaining the function reference method of a development tool described above. FIG. 2 illustrates an example of a function reference method of a development tool according to an exemplary embodiment of the present invention. Referring to FIG. 2, when a user is about to search for or load a function, he only needs to click on the add-in module button 210 in the development tool. The add-in module then connects to an external function database for reading a function database classified file 220 and displays all the function database types 230 contained in the function database classified file 220 in window 200, the function database types 230 may include “GUI_APIs”, “WM_APIs”, “LCD_APIs”, “FONT_APIs”, “INPUT_APIs”, and “OUTPUT_APIs”. Here if the user selects the function database type “GUI_APIs”, the add-in module displays all the secondary function database types 240 contained in the function database type “GUI_APIs”, which may include “GUI_Draw”, “GUI_Screen”, “GUI_Panel”, “GUI_Message”, and “GUI_Control”. Next, if the user selects the secondary function database type “GUI_Draw”, all the functions 250 contained in the secondary function database type “GUI_Draw” are displayed, which may include “Function#1”, “Function#2”, . . . , “Function#N”, etc.

Here if the user decides to search for the function “Function#1”, the user can load the function prototype of the function “Function#1” (for example, “Function#1(a,b,c)”) into the editing workspace of the development tool by dragging and dropping the item “Function#1” displayed in the window into the editing workspace of the development tool or by pressing down the input button while the item “Function#1” is highlighted. With the method described above, the user can search for and load the desired function conveniently through the hierarchical menu provided by the present invention even when the function database is new to the user.

According to another embodiment of the present invention, new function database and classified data which are to be provided for users are described with a text file or a database format file. The file is placed in a sorted directory and is read by an add-in module. Functions corresponding to a string input in the editing workspace of the development tool by a user are quickly located and listed so that the user can use the new function database for programming.

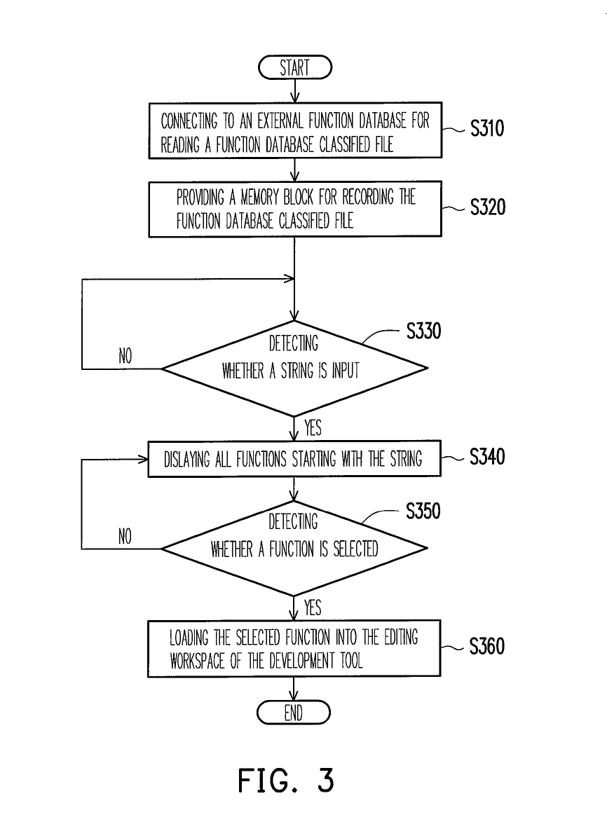

FIG. 3 illustrates a function reference method of a development tool according to another exemplary embodiment of the present invention. Referring to FIG. 3, similar to the previous embodiment, in the present embodiment, an add-in module is also used for connecting to an external function database to read the function database classified file (step S310). Wherein the function database classified file includes a plurality of functions, and the add-in module may be a hierarchical module added in the tool list of the development tool for providing function classification information for the users.

Similarly, the add-in module provides a memory block for recording the function database classified file when the add-in module reads the function database classified file (step S320), and later on when a user searches for function data, the function database classified file can be accessed directly from the memory, so that the user can browse and search for functions quickly.

Next, the user inputs the initial string of the function title in the editing workspace of the development tool, and here the add-in module detects whether a string is input (step S330). If the add-in module detects that a string is input, the add-in module searches for all functions starting with the string in the function database classified file and displays all the functions in the window for the user to browse and select (step S340); otherwise, the process returns to step S330 to continue the detection of input string.

If the string input by the user is a letter, all functions starting with the letter are displayed, while if the input string contains a plurality of letters and the input intervals between these letters are shorter than a particular time, all functions starting with these letters are displayed. For example, if the user inputs “A”, all functions starting with “A” are displayed, and when the user inputs “AB” and the input interval between “A” and “B” is less than 0.1 second, all functions starting with “AB” are displayed instead of searching for functions starting with “A” first, so that the speed and convenience in searching the functions are improved. It should be mentioned here that if the user inputs letters one by one slowly, the add-in module also combines each input letter with the previously input letters for searching for the desired function in the function database classified file.

Finally, the user selects the desired function from the displayed functions, and here the add-in module detects whether a function is selected (step S350). When the add-in module detects that a function is selected, the add-in module loads the selected function into the editing workspace of the development tool (step S360), otherwise, the process returns to step S350 to display all the functions starting with the input string. Wherein the selected function is loaded into the editing workspace of the development tool by dragging and dropping the function into the editing workspace of the development tool or by pressing down an input button, but which is not limited thereto as such.

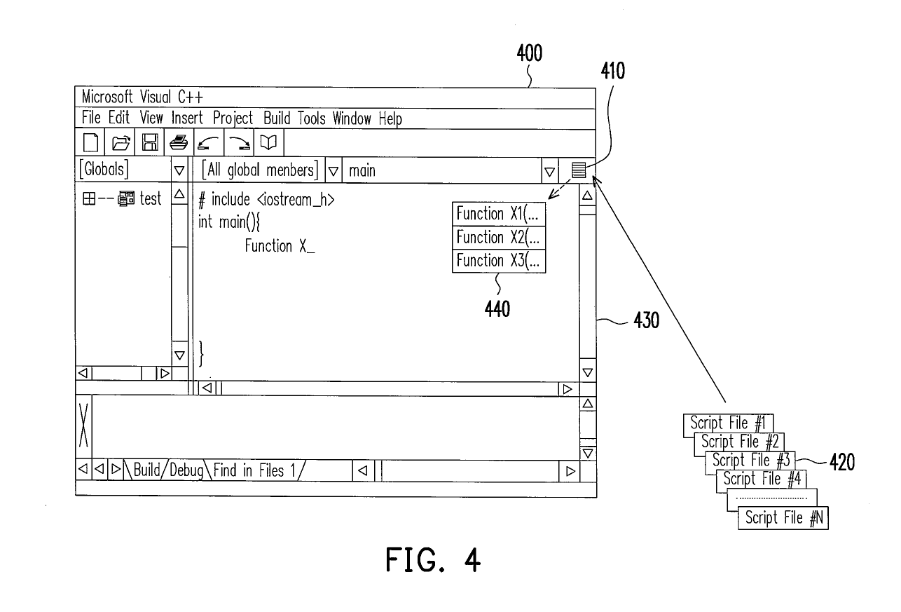

Another embodiment of the present invention will be described in detail below for explaining the function reference method of a development tool described above. FIG. 4 illustrates an example of a function reference method of a development tool according to another exemplary embodiment of the present invention. Referring to FIG. 4, when a user is about to search for or load a function, the user only needs to click on the add-in module button 410 in the development tool. The add-in module then connects to an external function database for reading a function database classified file 420 and detects a string input by the user in the editing workspace 430 of the window 400 of the development tool. When the user inputs a string of “Function x”, the add-in module locates 3 functions 440 starting with “Function x” in the function database classified file 420 and displays the 3 functions 440 in the window 400 so that the user can locate or load the desired function quickly. If the user decides to search for function “Function x1”, the user loads the function prototype of the function “Function x1” (for example, “Function x1(a,b,c)”) into the editing workspace of the development tool by dragging and dropping the item “Function x1( . . . ” displayed in the window 400 into the editing workspace of the development tool, or by directly pressing down an input button while the item “Function x1( . . . ” is highlighted. With the method described above, the user can search for and load the desired function conveniently through the hierarchical menu provided by the present invention even when the function database is new to the user.

In addition, as described in previous embodiment, if the number of functions to be displayed exceeds the display range of a page, a scroll bar or a PageUp/PageDown button is provided in the display window for the user to browse and select the desired function.

The present embodiment may also be applied to an object-oriented development tool, wherein the object classes and member functions/variables of the development tool are classified by the add-in module and the desired object class or member function/variable is located and displayed by detecting a string input by the user. Wherein the symbol “.” or “->” input by the user is used for determining the separation between an object class and member function/variable thereof. For example, in the description “ClassA.ClassAB.VariableA” of object A, the symbol “.” in the middle separates the object class and the member variable, while in the description “ClassC->ClassD.FunctionA” of object C, the symbol “->” is used as the separation. However, it should be understood by those skilled in the art that the present invention is not limited to foregoing applications, and other symbol or text may be used for searching for the desired object or function according to the actual requirement.

In summary, according to the function reference method of a development tool provided by the present invention, new function database and classified data to be provided for users are described with a text file or a database format file, which is placed in a function database classified file for an add-in module of the development tool to read. The desired function or object is located and loaded through a hierarchical menu or a string input by the user, thus, the user can search for and load new functions conveniently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A function reference method of a development tool, suitable for searching and loading a function in the development tool, comprising:
connecting to an external function database for reading a function database classified file by an add-in module, wherein the function database classified file comprises a plurality of function database types, and each of the function database types comprises a plurality of functions;
displaying the functions corresponding to the selected function database type when the add-in module detects that one of the function database types is selected; and
loading the selected function into an editing workspace of the development tool when the add-in module detects that one of the functions is selected.

2. The function reference method as claimed in claim 1, wherein a memory block is further provided for recording the function database classified file after reading the function database classified file.

3. The function reference method as claimed in claim 1, wherein if the number of function database types or functions to be displayed exceeds a page, a scroll bar or a PageUp/PageDown button is further provided for a user to select the function database types or the functions quickly.

4. The function reference method as claimed in claim 1, wherein the selected function is loaded into the editing workspace of the development tool by dragging and dropping the function into the editing workspace of the development tool.

5. The function reference method as claimed in claim 1, wherein the selected function is loaded into the editing workspace of the development tool by pressing down an input button.

6. The function reference method as claimed in claim 1, wherein if the selected function database type further comprises a plurality of secondary function database types, the step of displaying the functions corresponding to the function database type further comprises displaying the secondary function database types.

7. A function reference method of a development tool, suitable for searching and loading a function in the development tool, comprising:
connecting to an external function database for reading a function database classified file using an add-in module, wherein the function database classified file comprises a plurality of functions;
displaying a plurality of functions related to an input string when the add-in module detects the string; and
loading the selected function into an editing workspace of the development tool when the add-in module detects that one of the functions is selected.

8. The function reference method as claimed in claim 7, wherein a memory block is further provided for recording the function database classified file after the step of reading the function database classified file.

9. The function reference method as claimed in claim 7, wherein if the input string is a letter, all the functions starting with the letter are displayed.

10. The function reference method as claimed in claim 7, wherein if the input string comprises a plurality of letters and the input intervals between the letters are shorter than a particular time, all the functions starting with the letters are displayed.

11. The function reference method as claimed in claim 7, wherein if the number of functions to be displayed exceeds a page, a scroll bar or a PageUp/PageDown button is provided for a user to select the functions quickly.

12. The function reference method as claimed in claim 7, wherein the selected function is loaded into the editing workspace of the development tool by dragging and dropping the function into the editing workspace of the development tool.

13. The function reference method as claimed in claim 7, wherein the selected function is loaded into the editing workspace of the development tool by pressing down an input button.

14. The function reference method as claimed in claim 7, wherein the function database classified file comprises a text file or a database format file.

15. A function reference system of a development tool, comprising:
a storage unit, suitable for storing a function database classified file of the development tool, wherein the function database classified file comprises a plurality of function database types, and each of the function database types comprises a plurality of functions;
a display unit, suitable for displaying the function database types and the functions; and
an add-in module, suitable for connecting to an external function database for reading the function database classified file, storing the function database classified file into the storage unit, detecting the selected function database type or the selected function, and providing the selected function database type for the display unit to display or loading the selected function into an editing workspace of the development tool.

16. The function reference system as claimed in claim 15, wherein if the add-in module detects that one of the function database types is selected, the functions corresponding to the function database type are provided for the display unit to display.

17. The function reference system as claimed in claim 16, wherein if the add-in module detects that one of the functions displayed by the display unit is selected, the add-in module loads the selected function into the editing workspace of the development tool.

18. A function reference system of a development tool, comprising:
a storage unit, suitable for storing a function database classified file of the development tool, wherein the function database classified file comprises a plurality of function database types, and each of the function database types comprises a plurality of functions;
a display unit, suitable for displaying the functions; and
an add-in module, suitable for connecting to an external function database for reading the function database classified file, storing the function database classified file into the storage unit, detecting an input string, searching for a plurality of functions corresponding to the input string in the function database classified file, and providing the functions for the display unit to display or loading the functions into the editing workspace of the development tool.

19. The function reference system as claimed in claim 18, wherein if the add-in module detects the input string, the add-in module searches for all the functions related to the string in the function database classified file and provides corresponding functions for the display unit to display.

20. The function reference system as claimed in claim 19, wherein if the add-in module detects that one of the functions is selected, the add-in module loads the selected function into the editing workspace of the development tool.
